(19) United States
(12) Patent Application Publication
(10) Pub. No.: US 2024/0248211 A1
(43) Pub. Date: Jul. 25, 2024

(54) GATED CAMERA AND GATED IMAGE ACQUISITION METHOD

(71) Applicant: THE TRUSTEES OF DARTMOUTH COLLEGE, Hanover, NH (US)

(72) Inventor: Petr BRUZA, Lebanon, NH (US)

(21) Appl. No.: 18/289,533

(22) PCT Filed: May 4, 2022
(86) PCT No.: PCT/US2022/027734

§ 371 Date: Nov. 3, 2023

Related U.S. Application Data
(60) Provisional application No. 63/184,078, filed on May 4, 2021.

(51) Int. Cl. G01S 17/89; G01S 17/18; G02B 26/08; H04N 23/55

(52) U.S. Cl. CPC G01S 17/89; G01S 17/18; G02B 26/0833; H04N 23/55

(57) ABSTRACT

A gated camera has an image-sensing device, a spatial-light modulator that directs part or all of an incident optical beam toward the image-sensing device or away from the image-sensing device under control of a controller; and a beam-directing element that directs the incident optical beam toward the spatial-light modulator. A gated image acquisition method includes controlling whether a temporal segment of an incident optical beam contributes to an image captured by an image sensor by directing the temporal segment either toward the image sensor or away from the image sensor. A method for spatially encoding a temporally-varying light signal comprising, for each of a plurality of temporal segments of the temporally-varying light signal selectively directing the temporal segment of the temporally-varying light signal to a respective region of an image sensor, or directing the temporal segment of the temporally-varying light signal away from the image sensor.

### CLAIM TO PRIORITY

The present document claims priority to U.S. Provisional Patent Application 63/184,078 filed 4 May 2021. The entire contents of the aforementioned patent application are incorporated herein by reference.

### BACKGROUND

Temporally gated visible-light cameras are standard equipment in laser sciences, transient spectroscopy applications, lidar, and biomedical cameras. Standard sensors do not allow for fast and repeated exposure and masking of pixels. Instead, many sensors include a form of light switch in the optical path. As standard image sensors are too slow and/or insensitive, these cameras often employ an image intensifier, which allows for gating operation down to sub-nanosecond gate widths and GHz repetition rates, while multiplying the image signal as is necessary because of the often very low duty cycle of this gating, and therefore extremely low levels of photons received during each exposure. In a typical mesoscopic application, the gating requirements are less stringent, typically with gate width on the order of microseconds and kHz repetition rates. In the latter case, image intensifier gating can pose difficulties in terms of low damage threshold, price, or size.

### SUMMARY OF THE EMBODIMENTS

In a first aspect, a gated camera includes a micromirror array switch and a high-sensitivity sensor, such as electron multiplying charge-coupled device (EM-CCD), or back illuminated complementary metal-oxide-semiconductor (CMOS) device. Any image sensor may be utilized as a sensor: however, high sensitivity sensors are advantageous for high signal-to-noise acquisition of a low duty cycle gated image. The micromirror array has advantages over standard shutters or larger MEMS light switches because of low mass and rapid response of the active elements of the switch, thereby having a fast transit time while being scalable to large areas without a performance decrease. A micromirror array is an array of micro-electromechanical mirrors that has a micron-scale pitch, between 5-10 micrometers for example, and a typical mirror count of matching standard video resolutions, for example XGA (1024×768 pixels) to 4K UHD (3840×2160 micromirrors). Most importantly, the small size of each micromirror allows for microsecond switching and transit times.

A gated camera includes a standard image sensor and a spatiotemporal light modulator incorporating a micromirror array. The micromirror array redirects light away from, or toward the sensor in a controlled manner, allowing temporal gating of the formed image in time scales as low as several hundred nanoseconds. This method and device replace a current state-of-the-art, gated, image intensifier equipped camera. In addition, selective operation of certain area within the micromirror array allows concurrent gating only in a specific region-of-interest within images.

In another mode of operation, similar to a streak camera, spatial encoding of a temporally-varying light signal is achieved by forming the image during micromirror switching. As the mirrors switch, they redirect the captured light to different locations depending on time after the start of switching action. This way, the temporally varying light information is recorded in a spatial domain across the image sensor.

### BRIEF DESCRIPTION OF THE FIGURES

FIG. 1 is a schematic diagram of a gated camera, in an embodiment.

FIG. 2 is a schematic diagram of a gated camera, in another embodiment.

FIG. 3 is a schematic diagram of a gated camera, in another embodiment.

### DETAILED DESCRIPTION OF THE EMBODIMENTS

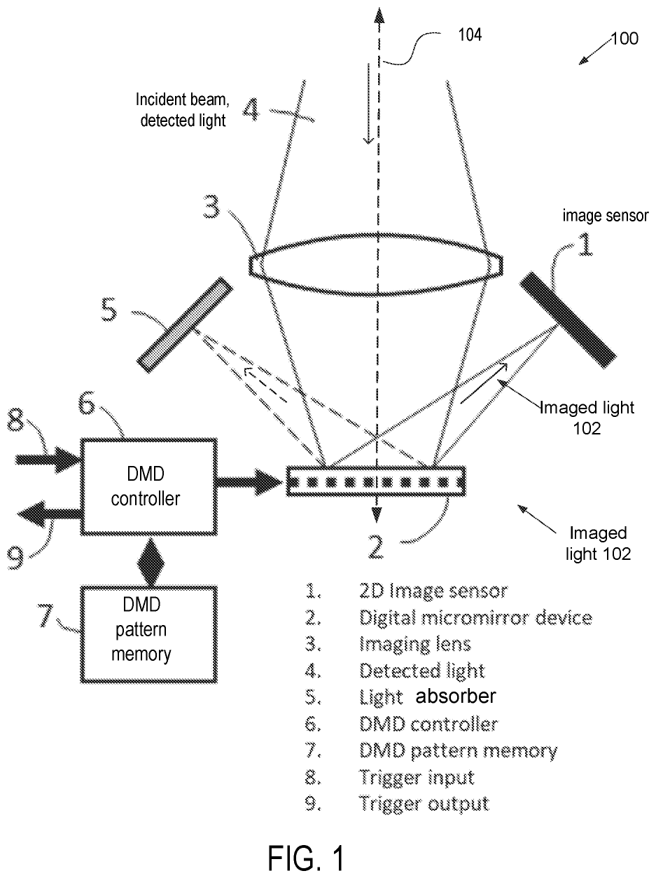

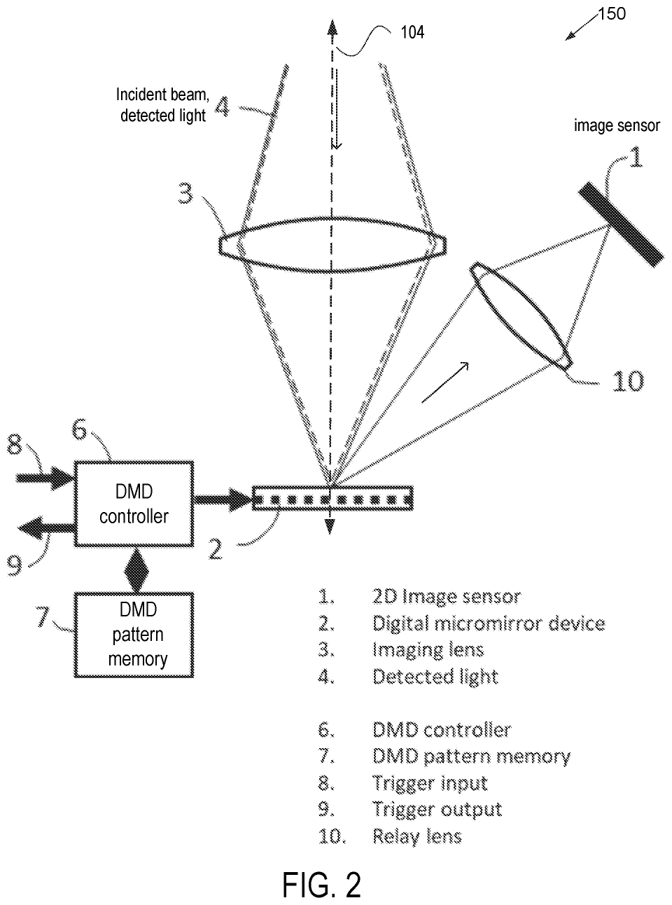

Each of FIGS. 1-3 depict a gated camera according to embodiments disclosed herein. FIGS. 1, 2 and 3 are best viewed together in the following discussion. In embodiments, a gated camera 100 includes an imaging lens 3, micromirror array 2 (otherwise known as a digital micromirror device or DMD), an electronic DMD controller 6, and an image sensor 1, as shown in FIG. 1. Electronic DMD controller 6 is communicatively coupled to DMD 2 to individually or collectively control micromirrors of DMD 2. In certain embodiments of camera 150 (FIG. 2), additional image forming lenses 10 are present between the DMD 2 and image sensor 1.

Detected light, or incident optical beam 4 enters the gated camera 100 from the scene being imaged through appropriate optics. For example, the scene being imaged may be an object being viewed under optical microscopy. Light is received on the DMD 2 and, when any one or more micromirrors of a desired portion of the DMD 2 are activated in a “view” direction, the received light is diverted as imaged light 102 to image sensor 1. When any one or more micromirrors of DMD 2 are activated in a NOT-view or divert direction, in embodiments of camera 100, the received light is diverted to a light block or absorber 5 that absorbs the diverted light. This helps to prevent stray light rays hitting image sensor 1. In camera 150 (FIG. 2), when at least one micromirror of micromirror array switch is in “off” or NOT-view mode, the received light is reflected back through imaging lens 3 and to the scene, thereby also directing an incident optical beam of detected light 4 away from image sensor 1. Incident optical beam of detected light 4 may be provided by a light source or illuminated scene and arrives along an optical axis 104: the incident beam does not intersect the image sensor 1 directly. In embodiments, the image sensor is oriented at an oblique angle with respect to the optical axis and is perpendicular to imaged light 102 that is diverted onto it by DMD 2.

The effect of each micromirror of both embodiments of gated camera 100, 150, is therefore to: when each individual micromirror is activated in “on” or “view” direction, incident received light is reflected into a propagation direction directing the received light onto image sensor 1, and when not activated or activated in a “NOT-view” direction, that light is diverted away from image sensor 1 to be either absorbed by light block or absorber 5, or sent back out through the imaging lens 3.

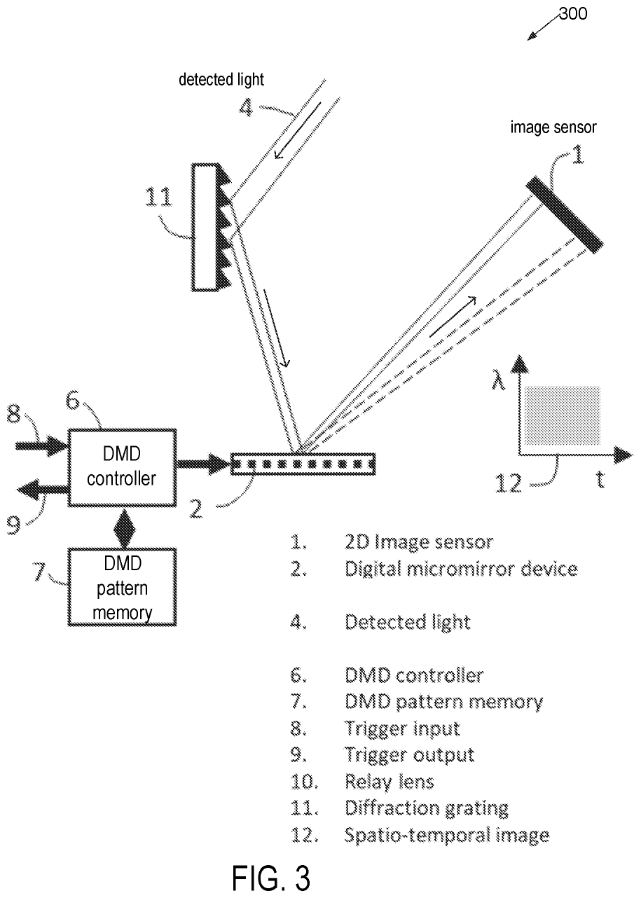

In yet another embodiment 300, imaging lens 3 is replaced with a diffraction grating 11 or other light modulating element, as shown in FIG. 3.

In an embodiment, image sensor 1 sensor is a low-noise CMOS sensor, allowing single or few-photon detection sensitivity. In another embodiment, image sensor 1 is an EM-CCD sensor, allowing for single photon sensitivity and fast gating despite a typically low readout rate of the EM-CCD. In embodiments, image sensor 1 receives light through its surface.

In an embodiment, a plurality of sensors, e.g., pixels, of image sensor 1, is used to separately detect images at different temporal windows from other pluralities of sensors of image sensor 1. This is done by independently or individually programming the micromirrors of the DMD. Programming the DMD allows it to transit through a sequence of patterns or states that may be stored in a pattern memory 7. In embodiments, DMD controller 6 and pattern memory 7 operate under control of a processor executing machine-readable instructions from a memory (not shown). As an example of how the system may advantageously use multiple patterns from pattern memory 7, DMD controller 6 and pattern memory 7 may be preprogrammed with, for example, three patterns. Pattern A has a selected image portion of both bright and dim scene areas in the scene being imaged with out of image areas programmed to a state of OFF or NOT-view. Pattern B has dim scene areas in the scene being imaged with out of image and bright scene areas programmed to a state of OFF or NOT-view, Pattern C has all areas programmed to be OFF or NOT-view:

When image capture is desired, the DMD controller 6 may sequence through patterns A, B, and C to briefly expose (during pattern A) image sensor areas to bright scene areas, expose for a longer time (during pattern A and B) image sensor areas to dim scene areas, and then divert all incoming light away from the image sensor with pattern C while the image sensor is being read. The net effect of sequencing the three patterns (admit all to image sensor (pattern A), admit part to image sensor (pattern B), admit none to image sensor (pattern C) is to increase the dynamic range of the image sensor 1 by decreasing duration of exposure in known bright scene areas to an exposure duration less the exposure duration used in dim scene areas. In an alternative embodiment, image sensor 1 may be protected from extremely bright light such as the sun by having micromirrors in portions of the DMD corresponding to images of the sun be kept in OFF or NOT-view in all three patterns of a sequence. In other embodiments, sequences of more than 3 patterns may be used, and patterns used need not have overlapping regions of On or View micromirrors, the system may therefore be used to alternately image portions of a scene.

All mirrors of the DMD corresponding to each separately-treated segment or portion of the scene are typically set to a same tilt angle when set to the ON or View state. In embodiments, mirrors of different portions of segments of the scene may be set to the same tilt angle when in the ON or View state, and in alternative embodiments mirrors of different portions to distinct tilt angles in the ON or View state to perform, for example, simultaneous or time-differentiated superposition of portions of the image on the image sensor.

Micromirror array 2 in embodiments is controlled by an electronic DMD controller 6 whose action is synchronized by a trigger signal 8, which in embodiments is generated by auxiliary equipment. In one embodiment, this auxiliary equipment is a laser trigger. In other embodiments, this synchronization trigger is provided by a radiation detector that detects stray radiation from an X-ray or charged particle source. In a different embodiment, DMD controller 6 controls both micromirror array 2 and the auxiliary equipment through a trigger output 9.

Image sensor 1 includes a plurality of pixels, and in embodiments, exposes the pixels for a duration of several “on” and “off” states of DMD 2 prior charge transfer and readout. Here, the “on” and “off” states correspond to a state where incident optical beam or detected light 4 is redirected onto image sensor 1 to contribute to the final image or diverted away from image sensor 1 to prevent its contribution to the detected image, respectively. The duration of “on” and “off” states, as well as the delay from the synchronization trigger signal is pre-set in DMD controller 6, and may be either fixed or can vary in time.

In one embodiment, the delay is gradually increased in order to create a temporal scan of the studied scene relative to a trigger signal: for example a trigger signal may represent a light pulse at excitation wavelengths to a scene containing fluorescent and phosphorescent materials, and a sequence of images may be obtained each at a different time after an excitation wavelength pulse to provide a sequence of images from which areas of differing fluorescent or phosphorescent decay times can be measured. In embodiments, the delay is predefined before each image is captured.

In another embodiment, there is a plurality of pre-set combinations of the timing parameters, which are being cycled through for each image sensor frame. For example, there is a pair of parameters, one being set to capture light phenomenon under study (such as incident optical beam or detected lighti4) plus an ambient background light, and another parameter set is adjusted such that only ambient background light is captured. Subsequent image equalization and subtraction will allow separating the light phenomenon under study from the ambient background. In yet another embodiment, a specific area of the DMD 2 can be temporally switched at one time while the rest of micromirrors is either kept at certain state (“on” and/or “off”), or switched between states at different times.

A special method of spatial modulation of a temporally-varying light signal is also implementable on the hardware of FIGS. 1, 2, and 3 by utilizing a transient response of a DMD device used as micromirror array 2. As the micromirrors transit from one state to the other, they redirect incident optical beam 4 impinging upon them over an extended area of image sensor 1, thereby encoding the time along one axis of a pixel array of image sensor 1. In one embodiment, this allows recording time-resolved spectra in a single pulse event. Alternatively, this streaking action is repeated to increase signal-to-noise of the recorded time-resolved spectra.

### List of Acronyms and Initialisms

lidar: light distance and ranging
CCD: charge coupled device
CMOS: complementary metal-oxide semiconductor
DMD: digital micromirror device
EM-CCD electron-multiplying charge coupled device

### Combinations

Inventors anticipate that the various ideas herein disclosed may be combined in several ways, including:

A gated camera designated A including: an image-sensing device: a spatial-light modulator that directs an incident optical beam toward the image-sensing device or away from the image-sensing device: and a beam-directing element that directs the incident optical beam toward the spatial-light modulator.

A gated camera designated AA including the gated camera designated A, the beam-directing element being an imaging lens having an optical axis, the image-sensing device not intersecting the optical axis.

A gated camera designated AB including the gated camera designated A or AA, the image-sensing device having a light-sensing surface oriented at an oblique angle with respect to the optical axis.

A gated camera designated AC including the gated camera designated A, AA or AB, the spatial-light modulator intersecting the optical axis.

A gated camera designated AD including the gated camera designated A, AA, AB, or AC, further including a light source that generates the incident optical beam, the light source, the imaging lens, and the image-sensing device being spatially configured such that the imaging lens forms an image of the light source on the image-sensing device.

A gated camera designated AE including the gated camera designated A, AA, AB, AC, or AD, the beam-directing element comprising a diffraction grating.

A gated camera designated AF including the gated camera designated A, AB, AC, AD, or AE, the spatial-light modulator including a micromirror array.

A gated camera designated AG including the gated camera designated A, AA, AB, AC, AD, AE, or AF, further including a controller, communicatively coupled to the spatial-light modulator, and including a processor and a memory storing machine-readable instructions that, when executed by the processor, control the spatial-light modulator to direct light transmitted by the imaging lens either toward the image-sensing device or away from the image-sensing device.

A gated camera designated AH including the gated camera designated AG, the image-sensing device including at least one image sensor.

A gated camera designated AJ including the gated camera designated AH, the image-sensing device including an array of image sensors.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments.” and does not refer to all embodiments. The following claims are intended to cover all generic and specific features described herein, as well as all statements of the scope of the present method and system, which, as a matter of language, might be said to fall therebetween.

1. A gated camera comprising:
an image-sensing device;
a spatial-light modulator programmable to (i) direct all of an incident optical beam toward the image-sensing device, (ii) direct a portion of the incident optical beam toward and a portion away from the image-sensing device according to a pattern, and (iii) direct all of the incident optical beam away from the image-sensing device; and
a beam-directing element that directs the incident optical beam toward the spatial-light modulator.

2. The gated camera according to claim 1, the spatial-light modulator including a digital micromirror array.

3. The gated camera of claim 2, the beam-directing element being an imaging lens having an optical axis, the image-sensing device not intersecting the optical axis.

4. The gated camera of claim 3, the image-sensing device having a light-sensing surface oriented at an oblique angle with respect to the optical axis.

5. The gated camera according to claim 4, the spatial-light modulator intersecting the optical axis.

6. The gated camera according to claim 2, further comprising a light source that generates the incident optical beam, wherein the light source, the imaging lens, and the image-sensing device are spatially configured such that the imaging lens forms an image of the light source on the image-sensing device.

7. The gated camera according to claim 2, the beam-directing element being a diffraction grating.

8. The gated camera according to claim 7, further comprising a controller, communicatively coupled to the spatial-light modulator, and including a processor and a memory storing machine-readable instructions that, when executed by the processor, control the spatial-light modulator to direct light transmitted by the imaging lens either toward the image-sensing device or away from the image-sensing device.

9. A gated camera according to claim 8, the image-sensing device including at least one image sensor.

10. A gated camera according to claim 9, the image-sensing device including an array of image sensors.

11. A gated image acquisition method comprising:
controlling whether a temporal segment of an incident optical beam contributes to an image captured by an image sensor by directing the temporal segment either toward the image sensor or away from the image sensor.

12. The method of claim 11, directing the temporal segment comprising (i) directing the temporal segment toward a spatial-light modulator and (ii) controlling the spatial-light modulator to direct the temporal segment either toward the image sensor or away from the image sensor.

13. A method according to claim 12, directing the temporal segment toward a spatial-light modulator resulting in the temporal segment illuminating a spatial region of the spatial-light modulator, and controlling the spatial-light modulator comprising:
directing an entirety of the temporal segment either toward the image sensor or away from the image sensor.

14. A method according to claim 12, directing the temporal segment toward a spatial-light modulator resulting in the temporal segment illuminating a spatial region of the spatial-light modulator that includes a first sub-region and a second sub-region, and controlling the spatial-light modulator comprising:
directing the temporal segment that illuminate the first sub-region toward the image sensor; and
directing the temporal segment that illuminate the second sub-region away from the image sensor.

15. A method according to claim 14, wherein directing the temporal segment comprises
directing the temporal segment toward a micromirror array;
actuating a plurality of micromirrors of the micromirror array to provide a plurality of actuated micromirrors; and
spatially modulating a propagation direction of the temporal segment by reflecting with the plurality of actuated micromirrors.

16. The method of claim 15, the micromirror array being communicatively coupled to a controller, said step of actuating being executed after a predefined delay after the controller receives a trigger signal.

17. A method according to claim 16, said predefined delay being zero.

18. The method of claim 15 the micromirror array being communicatively coupled to a controller, the step of actuating comprising independently actuating each of the plurality of micromirrors according to a trigger signal received by the controller.

19. A method according to claim 18, the micromirror array being communicatively coupled to a controller, and further comprising generating, with the controller, an output trigger signal that is synchronized with a state transition of at least one of the plurality of actuated mirrors.

20. A method according to claim 14, the spatial light modulator being communicatively coupled to a controller, and further composing generating, with the controller, an output trigger signal that is synchronized with a state transition of at least one of the plurality of actuated mirrors.

21. A method for spatially encoding a temporally-varying light signal comprising, for each of a plurality of temporal segments of the temporally-varying light signal:
selectively directing the temporal segment of the temporally-varying light signal to a respective region of an image sensor, or directing the temporal segment of the temporally-varying light signal away from the image sensor.

22. The method of claim 21, further comprising, for each of the plurality of temporal segments of the temporally-varying light signal:
directing the temporal segment of the temporally-varying light signal comprising reflecting the temporal segment of the temporally-varying light signal with a micromirror array that includes a plurality micromirrors oriented at a same respective tilt angle, of a plurality of distinct tilt angles, with respect to a propagation direction of the temporally-varying light signal incident on the micromirror array such that each temporal segment of the temporally-varying light signal of the plurality of temporal segments of the temporally-varying light signal is reflected at a respective tilt angle of the plurality of distinct tilt angles.
